(19) United States
(12) Patent Application Publication
(10) Pub. No.: US 2020/0097256 A1
(43) Pub. Date: Mar. 26, 2020

(54) A CALCULATION DEVICE FOR ENCODED ADDITION

(71) Applicant: KONINKLIJKE PHILIPS N.V., Eindhoven (NL)

(72) Inventor: LEANDRO MARIN, MURCIA (ES)

(21) Appl. No.: 16/471,650

(22) PCT Filed: Dec. 20, 2017
(86) PCT No.: PCT/EP2017/083856

§ 371 Date: Jun. 20, 2019

(30) Foreign Application Priority Data
Dec. 20, 2016 (EP) 16205277.3

(51) Int. Cl. G06F 7/72; G06F 9/30; G06F 7/53; G06F 7/509; H04L 9/00

(52) U.S. Cl. CPC G06F 7/72; G06F 9/30007; H04L 9/002; G06F 7/509; G06F 7/5318

(57) ABSTRACT

An electronic calculating device (100) is provided arranged for encoded addition in an Abelian group N. The calculating device comprises a storage (140) configured to store encoded elements of the Abelian group N, an addition unit (150) arranged to add multiple encoded addends, wherein the addition unit is configured to form an encoded element comprising at least the encoded parts of the multiple encoded addends, and reduction unit (160) arranged to reduce an encoded element, by replacing in a sequence of the encoded elements, two encoded elements with a further encoded element.

### FIELD OF THE INVENTION

The invention relates to an electronic calculation device, an electronic calculation method, and a computer readable medium.

### BACKGROUND

In computers calculations are performed for various tasks. As computers are finite, these calculations often take place in finite groups. These groups are usually Abelian. An example of a group is arithmetic modulo a prime number, notated as [symbol] ₚ. A particular important group for computers is the group with 2ⁿ elements, [symbol] ₂ⁿ. Groups can be constructed in a variety of ways, for example, larger groups can be constructed by multiplying smaller groups.

In some applications, there is a desire to hide information about the execution of the program from an attacker. In the so-called white box attack model, an attacker is assumed to have detailed access to a running computer program. There is a desire to hide as much as possible from the attacker, even in this model. In particular, sensitive applications, such as banking applications, content protection, and the like, that use cryptography to hide information from an attacker may be vulnerable in the white box model. If an attacker were to read, say, a secret key that was used to encrypt information, then the attacker may be able to decrypt said information himself, thus obtaining financials, plain content and the like.

Protecting a general calculation flow is hard using current white box technology. For example, the paper “White-Box Cryptography and an AES Implementation” by Chow, et al., (included herein by reference) shows how one particular algorithm (AES) may be protected in the white-box model. This technology may not be directly applied to protect general computer programs, that is, not without extensive human analysis of the program. For example, direct translation, say, of the addition or multiplication operations to tables or table networks of the type described in Chow, would still allow an attacker to deduce when an addition or multiplication is performed, simply by observing which table network is accessed.

Unfortunately, an attacker has a wide array of options to attack white box implementation. Besides passive attacks, e.g., side-channel type attacks aimed at the intermediate values used in the program, an attacker can also use active attacks. For example, he can tabulate the intermediate values used during execution, and during execution interchange an intermediate value with an intermediate value observed at a different place of the program or during a different execution. In this manner, an attacker may hope to learn information about the encoding used on the intermediate values.

There is a desire to improve the hiding of data in white box resistant implementations.

### SUMMARY OF THE INVENTION

An electronic calculating device (100) is provided arranged for encoded addition in an Abelian group N. The calculating device comprises a storage (140) configured to store encoded elements of the Abelian group N, an addition unit (150) arranged to add multiple encoded addends, wherein the addition unit is configured to form an encoded element comprising at least the encoded parts of the multiple encoded addends, and reduction unit (160) arranged to reduce an encoded element, by replacing in a sequence of the encoded elements, two encoded elements with a further encoded element.

Since elements are encoded with based on elements of a group A or a group M which need not be explicitly represented in the calculation device the elements of group N are encoded. However, even though these elements are encoded, arithmetic, in this case addition, remains possible while in encoded form. This is an advantage. Furthermore, the calculation device has the further advantage that interchanging variable values with incompatible types will give undefined results, which do give less information to an attacker.

The calculating devices and methods described herein are suitable for white-box encoded addition in an Abelian group. In a white-box encoded addition, countermeasures have been taken which make it hard for an attacker to obtain details about the additions. The devices and methods may be combined with known obfuscation techniques to further improve the white-box protection that is obtained, e.g., code obfuscation. White-box encoded addition is particularly suitable to protect cryptographic applications. For example, in a cryptographic application a key may be comprised in the device, which should be inaccessible to an attacker of the device, e.g., to avoid unauthorized use of the key. White-box encoding may also be applied in a non-cryptographic context. For example, reverse engineering a proprietary algorithm, e.g., an image improvement algorithm, is more difficult if white-box encodings, such as described herein, are employed.

A method according to the invention may be implemented on a computer as a computer implemented method, or in dedicated hardware, or in a combination of both. Executable code for a method according to the invention may be stored on a computer program product. Examples of computer program products include memory devices, optical storage devices, integrated circuits, servers, online software, etc. Preferably, the computer program product comprises non-transitory program code stored on a computer readable medium for performing a method according to the invention when said program product is executed on a computer.

In a preferred embodiment, the computer program comprises computer program code adapted to perform all the steps of a method according to the invention when the computer program is run on a computer. Preferably, the computer program is embodied on a computer readable medium.

Another aspect of the invention provides a method of making the computer program available for downloading. This aspect is used when the computer program is uploaded into, e.g., Apple's App Store, Google's Play Store, or Microsoft's Windows Store, and when the computer program is available for downloading from such a store.

Reference is made to international patent application WO2016/050884 A1, with title “Electronic calculating device for performing obfuscated arithmetic”.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings,

FIG. 1 schematically shows an example of an embodiment of an electronic computation device,

FIG. 2a schematically shows an example of an encoded addition,

FIG. 2b schematically shows an example of a reduction,

FIG. 3 schematically shows an example of an embodiment of an electronic computation device arranged for AES,

FIG. 4 schematically shows an example of an embodiment of an electronic computation method,

FIG. 5a schematically shows a computer readable medium having a writable part comprising a computer program according to an embodiment,

FIG. 5b schematically shows a representation of a processor system according to an embodiment.

FIG. 6 schematically shows a representation of a diagram.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

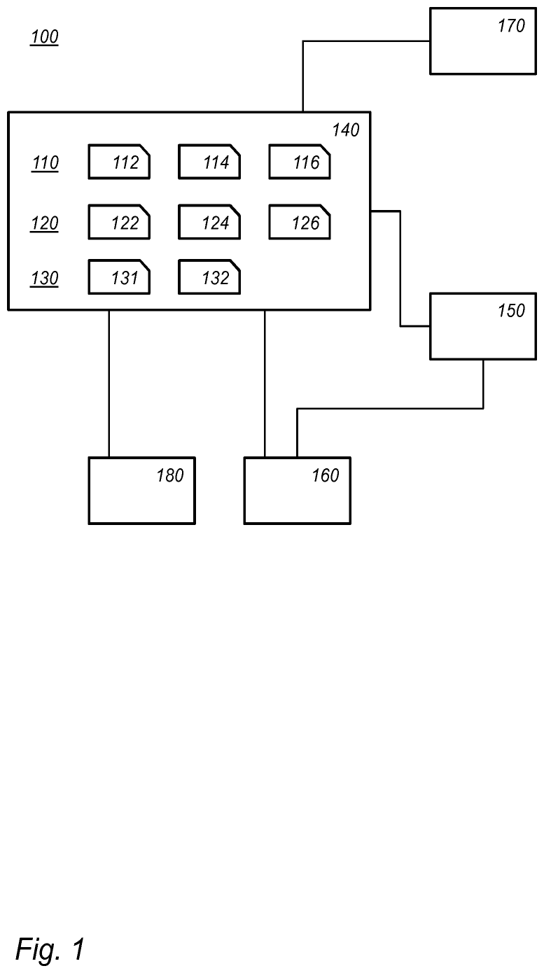

FIG. 1 schematically shows an example of an embodiment of an electronic computation device 100. Electronic calculating device 100 is arranged for encoded addition in an Abelian group N. For example, the Abelian group N may be [symbol] ₃× [symbol] ₁₂× [symbol] ₁₄. For example, the Abelian group N may be [symbol] ₂ⁿ. In particular, the Abelian group N may be [symbol] ₂⁸ or [symbol] ₂⁴. These latter two examples correspond to the natural data sizes occurring in existing computer programs or protocols, etc., and thus make it easier to convert such to an encoding method according to an embodiment.

Below we will show how the elements of the Abelian group may be encoded so that interchanging encoded values during execution by an attacker, will at least in some cases cause the program to malfunction, e.g., to produce a non-sense result. As result the scope for an attacker to learn about the encoding used by active attacks, in particular attacks based on interchanging intermediate values during execution of the calculating device is less like likely to produce results.

In some embodiment, we will use one or more of the following mathematical objects.

An Abelian group M and a homomorphic surjective projection π: M→N from M to N may be defined. The group M is Abelian. This object is optional, one may take M=N. In this case the projection π may be the identity. Using a larger group M to represent the smaller group N has several advantages. For example, M may be chosen so that it has an automorphism group that is larger than the automorphism group of N. As a result, more encodings are available for M than for N directly. Furthermore, M may be chosen to simplify calculations, for example, M may be a direct product of a group, e.g., M= [symbol] ₘⁿ. The fundamental theorem of finitely generated Abelian groups guarantees that this can always be done. For example, for the example, N= [symbol] ₃× [symbol] ₁₂× [symbol] ₁₄, one may chose M= [symbol] ₈₄³, since 84=3·4·7. In an embodiment, the dimension of M, e.g., the number n in this case, is at least 2, or at least 3, etc.

A subgroup H is chosen of the automorphism group of M. The group H is written as the product of two non-trivial subgroups G and A. That is H=GA. The subgroups are chosen to have the property that ga=ag for any a and g in A and G. In an embodiment, one could simply take H=Aut(M). But allowing a subgroup for H makes it smaller, which in turn causes fewer choices for the possible encodings. This may be an advantage, especially if some operations have to be implemented as a table lookup, e.g., non-linear operations and the like.

We will write the groups N and M, as additive groups, and the groups H, G, and A as multiplicative groups. However, this it is clear to the skilled person that way a group is written is irrelevant. The same group written multiplicatively would work the same when written additively, just with different wording. In both cases, we may write the identity as e.

The group M, or even N, may a module over a ground ring, the groups H, G and A being matrix groups over the ground ring. For example, elements of M may be written as vectors, with (possibly of encoded) elements of the ground ring of group. For example, if M= [symbol] ₘⁿ, then elements of M may be expressed as a vector of dimension n. In this case the automorphism group of M may be written as a set of n×n matrices. For example, a straightforward way to select a group A that works, is to take the set of all diagonal and/or anti-diagonal matrices, e.g., wherein each matrix has equal elements on its diagonal or anti-diagonal. The elements of G can be found by expressing the condition that ga=ag as linear equations. In an embodiment, A is a cyclic group, e.g., a cyclic group, e.g., a cyclic group of order 3. In an embodiment, A is idempotent. Both these two latter embodiments may be implemented as diagonal or as diagonal and/or anti-diagonal matrices.

A basis x is defined as a set x and a map [ ]: X→M. The map [ ] may be a partial function, e.g. undefined for some values in X, but the composition π[ ]: X→N is surjective. The following requirements are imposed on as basis. The set x has an H action, so for any h₁ and h₂ in H and x in X we have (h₁h₂)x=h₁(h₂x), and ex=x. The map respects this action, so that [xh]=[x]h for any x in x and h in H, where the function is defined.

At least one basis is defined for the Abelian group N. In practice, useful obfuscating encoding may be done using a single basis. However, multiple bases may be used as well. A second basis will be denoted as Y, we will use the same notation for its map [ ]: Y→M, as it will be clear from the context which map is used.

A practical way to construct basis is to a copy of H, or the disjoint union of multiple copies of H. One way of representing disjoint union of multiple copies of H is as pair (i, h) in which i is an index that denotes the coy of H and h is an element of H. For example, if k copies are used one may take X={(i, h): 1≤k, h∈H}. The required H action may be the natural group action. For example, if x is k disjoint copies of H, and h is an element of H, and x=(i, h₁) an element of X then the action hx may be (i, hh₁). Another way to construct a basis is have one or more disjoint union of multiple copies of G, or the disjoint union of copies of G and/or H. For example, if G∩A={e}, and A={a₁, a₂, . . . , aₖ}, then H=GA=Ga₁∪Ga₂∪ . . . ∪Gaₖ, and thus above construction can be used. To avoid a partial function one may set the map [ ] to random values whenever it is not defined. In a correct execution, the values where the map is not defined will not be used.

At least one reduction function w is defined, which is a function from a first set X to a second set Y, the function w having a type ((X, a, Y, a′, m)). A reduction function is also termed a ‘box’ function. The type of a reduction function comprises a first set X, second set Y, an element a of A, the element a′ of A, and an element m of the group M. The reduction function w has the property that [xa]+m=[W(x)a′] for all x in X, a and a′ in A, m in M, for which the map [ ] is defined. Note that the [ ] on the left-hand side is the map from x to M, whereas the [ ] on the right-hand side is the map from Y to M. In the definition of a reduction function, it is allowed that the first and second sets x and Y are the same. Multiple reduction functions may be defined. Note that once the maps [ ] are fixed for the sets x and Y a reduction function w be computed there from. For example, given an x in X one may compute ([xa]+m)a′⁻¹ which is an element of M. Inverting this element for the map of Y gives a value for w(x); note that there may be multiple solutions. The reduction function w may also be a partial function, however, the composition π([W( )]) is surjective on N.

We can now define encodings of elements of Abelian group N. Group elements can be encoded in three main ways, or forms. The first and second forms come in multiple types. The third form is a hybrid of the first and second form.

In a first form, an element of Abelian group N is represented in the calculation device as an element of the set X. The first form is also called a hook. A hook has a type defined by the set X, and an element b of a group A. The type of a hook is denoted as [symbol] (X, b). An element x of type [symbol] (X, b) represents the element π([x]b) of the Abelian group N. Herein, the set X is a basis. Note that even for a single basis x many different types of hooks can be defined, by varying the element b of A. If multiple sets are allowed, the number of types increases yet more. Note that even if the element x may occur in the program, the value in N that it represents is unknown to the attacker because an attacker does not know the value b. The value b does not need to occur anywhere in the program.

In a second form, an element of Abelian group N is represented in the calculation device as an element of the group G. The second form is also called a link. A link has a type defined by an element m of M and an element b′ of A. The type of a link is denoted as [symbol] (m, b′). An element g of type [symbol] (m, b′), e.g., an element g of G, represents the element π(mgb′) of N.

In a third form, an element of Abelian group N is encoded as a sequence of encoded elements, wherein the sequence in the third form comprises at least two encoded elements encoded according to the first or second form. The third form may be implemented as a formal sum, or as a set, comprising encoded element. The encoded elements are encoded according to the first and second encoding. The sequence of encoded elements represents the sum in the Abelian group N of the elements in the Abelian group N that are represented by the elements in the sequence. We may refer to encodings of the third form, e.g., as formal sums. Formal sums make adding two encoded elements very straightforward, in an embodiment. One can simply join or concatenate the two addends to obtain an addition encoded in the third form.

For example, a first operand may be represented as a first sequence of a hook and zero or more links, the types of the hook and links may be different. The element of N represented by the first operand is the sum of the elements of N represented by the hooks and links in the first sequence. A second operand is represented as a second sequence of at least one link. The types of the links in the second sequence may be different. The element of N represented by the second operand is the sum of the elements of N represented by the links in the second sequence. The sum of the first operand and the second is represented by a third sequence comprising the hook and zero or more links of the first sequence and the links of the second sequence.

Using a reduction function some pairs of a hook and a link can be reduced.

However, not all pairs of hooks and links may be reducible, and not all pairs that are reducible need be reducible by the same reduction function. A reduction step is applied to the third sequence by replacing a hook x of type [symbol] (X, ab) and a link g of type [symbol] (m, b) in the third sequence with a hook W(xg⁻¹)g of type [symbol] (X, a′b). This needs a reduction function W of type (X, a, Y, a′, m). If an attacker interchanges data, there is good chance that the switched data elements are no longer of the correct types for the particular reduction function. As a result, the program will produce undefined values

One may verify mathematically that the result of applying a reduction operation to a third form element obtains a new encoded element of the first or third form which represents the same value.

Element of N may thus be encoded according to a first or second form, each in different types, or as a sequence of one or more of first and/or second form encoded elements. An encoded element of a type of the first form ( [symbol] (X, ab)) being defined by a set X, and element ab of the group A and an encoded element of a type of the second form ( [symbol] (m, b)) defined by an element m of the group M and an element b of the group A are compatible if the reduction unit is arranged with a reduction function W of type (X, a, Y, a′, m). In this case the hook and link can be reduced to, e.g. replaced by, a new hook. Converting a link to a hook can be done by adding a hook representing the identity of N. Such a hook can be precomputed. Adding two hooks is more complicated. For example, it can be done by having a look-up table that converts a hook to a link, or a third form encoding that does not comprise a hook, but only links.

In an embodiment, the values of the various sets and groups, in particular elements of a basis X or the elements of group G may be represented in a traditional encoded form. For example, they may be encoded as an index in the larger set of group. For example, to execute the above reduction one may compute the value xg⁻¹, e.g., using a look-up table that takes a representation of x, e.g., a traditional encoding of x, e.g., an index in the set X. The result of this may be presented to a look up table for W. Finally, a multiplication with g may be performed, e.g., using a third look-up table. Note that the first and second look-up table, or all three tables, etc. may be combined into a single table. For example, a single table that takes as input representations of x and g. Note that the index representation may be randomized; there need not be any logical relationship between the value of the index and the element of X or G represented. For example, a random permutation may be applied to x and/or G after which an element is represented as an index in the permuted set or group.

Returning to FIG. 1. Calculating device 1 comprises a storage 130 configured to store encoded elements of an Abelian group N. The storage may comprise elements encoded according to any of the three forms.

Shown in FIG. 1, storage 140 comprises three elements of the first form, also known as hooks. For example, hook 112 and hook 114 may have the same type [symbol] (X, b), but hook 116 may have a different type, say [symbol] (X, c) or [symbol] (Y, c), with Y a different basis, and/or c a different element of A.

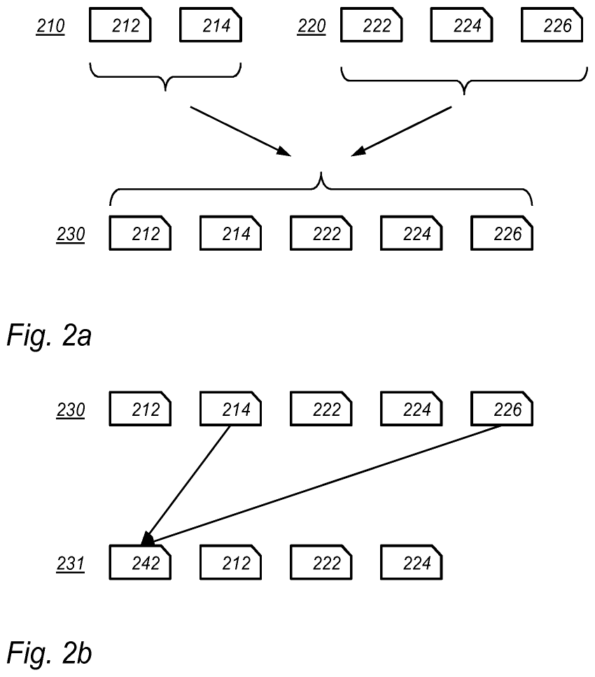

Shown in FIG. 2, storage 140 comprises three elements of the second form, also known as links. For example, link 122 and link 124 may be of type [symbol] (m, b′), but link 126 may have a different type, say type [symbol] (m, b″) and/or [symbol] (m′, b″), etc. Shown in FIG. 2, storage 140 comprises three elements of the third form. An element of the third form strings together a hook and/or multiple links. As reduction for two hooks is more complicated than reduction for a hook and a link, it is preferred that a third form encoded element comprises at most one hook. For example, encoded element 131 may be a sum of a hook and a link; e.g., an incompatible hook and link. For example, encoded element 132 may be a sum of a link and a link, e.g. of different types. Depending on the application, a calculation device may allow a third form to comprise two or more hooks. For example, if data from different sources needs to be added it may be hard to avoid having two hooks in a single third form encoded element. On the other hand, if an encoded computation takes place fully under a single control, e.g., a devised by a compiler, or a human coder, it can be possible to avoid having third form encoded elements with two hooks altogether. For example, in an embodiment, most encoded elements consist are second or third form encoded consisting only of links; only an accumulator to which these encoded link-only elements are added comprises a hook. In that case, reductions are only done on the accumulator. Note that for the addition it does not matter what the types or forms of an element are, as addition is simply the union of the addends, e.g., concatenation.

Calculation device 100 further comprises an addition unit 150 arranged to add multiple encoded addends. For example, addition unit 150 may be arranged to add two addends, e.g. inputs for additions, and/or addition unit 150 may be arranged to add more than two elements. Interestingly, addition is surprisingly simple in this system. To add two numbers, it suffices to make a third form element that comprises the encoded elements of the addends. As a third form element is defined to represent the sum in Abelian group N of the encoded elements that it comprises, the union of addends automatically represents the sum of the addends, e.g., the values to be added. Because group N is Abelian, the order in which the components of the third form are listed is irrelevant; any order in which the components of a third form element, e.g., the first or second form elements, are listed represents the same addition result.

For example, addition unit 150 may be arranged to retrieve a first addend and a second addend from storage 140 and to write an addition result in third form to the storage 140. For example, a third form may be implemented as a linked list, or as an array etc. For example, in case of the former, the addition result may not require copying of the components of the addends, as it may suffice to create pointers to the components of the addends, e.g., the first or second form encoded elements comprised in the addends. Nevertheless, also if pointers are used a copy of the inputs components may be made.

FIG. 2a schematically illustrates a way to add to encoded elements. Shown in FIG. 2a are two encoded elements of the third form: elements 210 and 220. Each element comprises multiple encoded elements of the first or second form. For example, third form element 210 comprises encoded elements 212 and 214. For example, element 214 may be a hook, while element 212 may be a link. For example, third form element 220 comprises encoded elements 222, 224 and 226; for example, these may all be links. It is not forbidden to add hooks to each other in this way; this addition mechanism is very flexible. However, reducing two hooks may require additional infrastructure, e.g., a table mapping a combination of two hooks, or at least two hooks of some types, to a first/second or third form element comprising at most one hook. For example, a first hook plus second hook addition table may be included only if the first hook is of a particular first type, and the second hook is of a particular second type. One or a few such tables will already enlarge the scope to add element considerably. Especially considering that changing the type of a hook is possible with the reduction system, e.g., by adding links of known value and type, e.g., that represent zero.

FIG. 2a further shows the addition of addend 210 and addend 220, namely addition result 230. Result 230 is also a third form element and comprises the elements in the addends 210 and 220.

Returning to FIG. 1. Calculation device 100 further comprises a reduction unit 160 arranged to reduce an encoded element of the third form. Without reduction, addition results would become longer and longer, but reduction shortens a third form representation. Reduction unit 160 is arranged to replacing in the sequence of the encoded elements of a third form encoded element a hook and a link with a new hook, replacing the original hook and link. As a result, the representation becomes one component shorter. Furthermore, the number of hooks in a third form element does not change as a result of the reduction. In particular, if all elements comprise a maximum number of hooks, in particular at most one hook, then this invariant is respected by the reduction operation. Interestingly, the same reduction operation does is not necessarily work on any hook and link combination, rather a reduction operation puts requirements on the types of input, e.g., on the type of the hook and the type of the link. This means that re-arranged data in a running computer program according to an embodiment, will likely produce nonsense result, as reduction will be attempted with incompatible types.

The reduction unit 160 is provided with a reduction function w. For example, reduction unit 160 may comprise a reduction function w unit. For example, reduction unit 160 may comprise computer program code implementing the reduction function. For example, the reduction function w may be implemented as a look-up table.

The reduction function w is a function from a first set X to a second set Y, and has a type ((x, a, Y, a′, m)) defined by first set x, second set Y, the element a of A, the element a′ of A, and the element m of the group M. The type of the reduction function determines which hook-link combinations it can reduce, and the type of resulting hook. The function w also has the property that [xa]+m=[W (x)a] for all x in X, a and a′ in A, m in M, for which the map [ ] is defined.

Reduction unit 160 is arranged to obtain
a first encoded element x of the first form of type defined by the set X and an element ab of the group A and
a second encoded element g of the second form of type defined by an element m of the group M and an element b of the group A,

In other words, the element of A that defines the type of the hook is a times as much as the element of A that defines the type of the link.

Reduction unit 160 replaces the hook and link obtained as inputs with an encoded element of the first form, e.g., a hook, w(xg⁻¹)g of type ( [symbol] (Y, a′b)) defined by a second set Y and the product (a′b) of an element a′ and the element b.

Calculation unit 100 may be arranged to activate reduction unit 160 after each addition of addition unit 150. This will keep third form elements as short as possible. Reduction may be applied multiple times until no further reduction is possible. Alternatively, calculation unit 100 may also be arranged to postpone reduction, e.g., after a number of addition, e.g. a predetermined number, has been performed. For example, calculation device 100 may apply reduction if a number has more than some number of components, e.g., hooks and/or links. For example, reduction may be applied to any third form element, having 4 or more hooks and/or links. The number 4 may be 2 or more, 3 or more, etc.

Interestingly, in an embodiment storage 140 may store a first addend of the third form that comprises an encoded element of the first form and an encoded element of the second form, that are not compatible, e.g., to which no reduction function of reduction unit 160 applies. Thus, this second form cannot be further reduced. Storage 140 may further comprise a second addend comprising an encoded element of the second form compatible with the encoded element of the first form in the first addend. After these first and second addends are added a third form is created comprising a hook and link that are compatible. The reduction unit can be applied to the sum of the first and second addend and a shorter third form may be created. If an attacker maliciously switched the first addend or the second addend with numbers found elsewhere in the program, then they may be of the wrong type. The resulting addition will then produce bogus results. Alternatively, if the switch causes undefined values to be called, this may be resolved by substituting random values, e.g., predetermined values, or possibly even by producing other undefined behavior, e.g., an error message, a crash and the like. An advantage of substituting a random value, or some predetermined non-random value, etc., is that the attacker does not receive feedback on whether the switch was illegal or not.

FIG. 2b schematically illustrates one way to perform a reduction process. Shown in FIG. 2b is the addition result 230 obtained from the example given with respect to FIG. 2a. Addition result 230 comprises a hook 214 and a compatible link 226. The reduction process replaces hook 214 and link 226 with a new hook 242. The reduction result 231 comprises new hook 242, and links 212, 222 and 224 which were also present in the addition result 230. Hook 214 and link 226 are not present in reduction result 231.

The addition of a hook and a chain is just a formal addition of both operands making a longer chain. The reduction step is applied to a hook that has at least one link and combines the hook with this link. A reduction path is the precise order in which a hook with several links can be reduced, for example, consider the chain H+L¹+L²+L³. A reduction path could be (1,3,2) and other one (3,1,2). These paths mean that the order of the operations would be:
Reduction path (1,3,2)
   1. H+L¹→H′
   2. H′+L³→H″
   3. H″+L²→H′″
Reduction path (3,1,2)
   1. H+L³→K′
   2. K′+L¹→K″
   3. K″+L²→K′″

The result in the first case is H′″ and in the second it is K′″. Both represent the same element in M, but maybe with different types because the reduction paths could follow different trajectories. In general, with if there are many types, the reduction paths are less likely to produce a unique result, even if they have the same origin and end in the types.

Note, that a reduction path could be in some cases a partial reduction, e.g., not fully to a first form element, this means that the result does not eliminate all the links, because some of them are there for further reductions or operations.

Interestingly, the elements of M or A need not be represented in the program; this aspect is very desirable. They may be regarded as virtual or “phantom” elements, used only implicitly in an implementation, e.g., a computer program, or in correctness proofs that show the results are correct, but they never appear in the program. The program has elements of X and elements of G. These may also be encoded in various, e.g., traditional ways.

By design, not all possible additions can be reduced. Even if reduction is possible, a precise order is needed to ensure the reductions are possible. In some cases, we could be interested in making transformations of links and/or hooks to other ones that represent the same value, but have different types. This will be called a jump. Suppose that we have elements g₁, . . . , gₖ in G and a₁, . . . , aₖ such that gᵢa₁++gₖaₖ=Id_{M}, e.g., the latter element is the identity matrix with only ones on the main diagonal. Given a link with value mga, we can now compute mga=mga·Id_{M}=mga(g₁a₁+ . . . +gₖaₖ)=mgg₁a₁a+ . . . +mggₖaₖa. The latter can be regarded as a sum of links, but with different types. In this way, a single link is expanded to multiple, e.g., at least two, new links but with different types. The new links may be combined with other hooks. For example, the reduction unit 160 may be extended with this functionality, or a new expansion unit may be introduced that is arranged for this expansion.

Returning to FIG. 1. Calculation device 100 may comprise an optional input unit and/or an optional output unit. In the embodiment shown in FIG. 1, a combined input/output unit 170 is shown. In an embodiment, a separate input unit and output unit may be used.

For example, I/O unit 170 may be arranged with a plain input arranged to receive an element of Abelian group N, and to convert the received element into an encoded element of the first, second or third form, e.g., using a look-up table. For example, I/O unit 170 may be arranged with a plain output arranged to receive an encoded element of the first, second or third form and to convert the received element to an unencoded element of Abelian group N. In this context unencoded means, not encoded according to the first, second or third form. The input and output may very well be encoded according to an external encoding scheme.

For example, the input and/or output may receive or produce one or more elements of group N in plain form, e.g., in some canonical representation of the group N, e.g., as an integer modulo a modulus, e.g., as a vector, e.g. modulo component-wise moduli, etc. For example, the input and/or output may receive or produce one or more elements of group N in encoded form, e.g., as an index in group N, in particular, after group N has been permuted with some encoding permutation, e.g., an encoding of group N. The encoding used may comprise some form of salt, e.g., a state, to avoid that equal elements of group N always correspond to the same encoding.

Encoding for the input or output may conveniently be done by a look-up table. For example, at the input, an input element of N may be mapped to some, first, second or third form representation of the same element. There may be multiple ways to represent the same element. At the output, a table may map a first, second or third form element to an output. Note that this is not always needed, e.g., if the data is stored for later use by the same calculating device, then the first/second/third form encoding can remain intact. To keep tables small, it is preferred that reduction is applied before converting an element for output.

Calculating device 100 may optionally comprise a linear operator unit 180. Linear operator unit 180 is arranged to apply a linear operator to an encoded element. A linear operator applied to third form encoded element is equal to the linear operator applied to the hooks and links in the third form encoded element individually. For example, a linear operator, e.g., f: M→M, or from N to N, has the property that f(L¹+L²+ . . . +L^{t})=f(L¹)+f(L²)+ . . . +f(L^{t}), therefore it suffices to have tables that given a link, e.g., an element of G, recall that a link is represented by an element of G, gives the value off over this link as a sum of links. A typical example would be the linear maps given by G→GxGxG. In general G is smaller than M and these tables would not be especially large compared with tables that go from x to other set, especially if x is given by multiple copies of G, then a table G→G^{t} will have the size t|G|log₂(|G|), but a table G^{t}→G^{r} will have the size r|G|^{t} log₂(|G|) that will be much bigger because of the exponent t.

In an embodiment, linear operator unit 180 is restricted to apply the linear operator to links, e.g., to elements of the second form or links-only elements of the third form. When we have to apply linear operators, it is better to use links. It is preferred to use hooks only when we have to make the reductions. For example, in AES we may use the S-Box that given a hook gives the output of the S-Box as a set of links, then we will make the linear operators represented by MixColumn and generate a long list of links that will be reduced with the hook and extra links provided by the key at the end of the round.

In an embodiment, a basis x is an Abelian group X, such that the group H is a common subgroup of the automorphism group Aut(X) and the automorphism group Aut(M). In this case, the basis X has an additional additive structure. For example, one may use an Abelian group X such that H is a common subgroup of Aut(X) and Aut(M). The additive structure of X need not be used for the operations, but it could be rather convenient to represent the elements of X in a compact way. For example, suppose that the matrices that represent H as automorphisms of X can be completely different from the ones in M, even with a different dimension and base field. And these matrices can be changed easily using the isomorphisms H→fHf⁻¹ given by h→fhf⁻¹ for any automorphism fin Aut(X). In this way, we have a compact representation and that reduces a lot the size of the tables because many of them, in fact all of them but the box operator, can be replaced by actual operations between matrices and vectors. To improve security, it is important in that case that the map [ ] is not linear, in particular it should not preserve addition because if it preserves the addition, the system could be analyzed with less effort.

When making reductions there it is a possibility to keep an administration in the calculation device 100, e.g., in storage 140 about the types of the various hooks and links. In this case, reduction unit 160 has the option to collect compatible hooks and links in the same third form and reduce them, e.g., by verifying the administration that the hook and link have a compatible type. However, it is preferred that type information is only implicit in the calculation device. For example, a compiler or even a human implementer can keep track of the types of variables and apply the correct reduction functions to them. In this way, an attacker cannot determine what the types of variables are. In general, it is known in advance which variables will be added to which variables. The compiler can keep track of the types of these variables. If needed, a compiler can first compute a static single assignment (SSA) graph for a portion of computer code. By unrolling loops the size of the portion of computer code for which the single SSA may be created may be increased. In the SSA graph, the compiler can assign types to the variables and determine at compile time which variables will be compatible and which will not be. For example, a compiler may optimize for incompatible types in variables, with the occasional opportunity for reduction.

Part of the additions may be addition of constants; the types of the constants may be determined by the compiler. The constants may be encoded in first/second/third form as desired, e.g., to optimize incompatible elements.

The reduction unit, addition unit, linear operator unit, and/or i/o unit may be implemented by the processor circuit, e.g., as multiple computer program instruction implementing the respective unit, and/or a circuit implementing the unit, and/or as a hybrid of dedicated hardware and software instructions.

In general, a look-up table may also be implemented as look-up table network, e.g., to break up large inputs into multiple smaller tables.

In the various embodiments, an input and output interface for the input and/or output unit may be selected from various alternatives. For example, an input and/or output interface may be a network interface to a local or wide area network, e.g., the Internet, a storage interface to an internal or external data storage, a keyboard, etc.

Storage 140 may be implemented as an electronic memory, say a flash memory, or magnetic memory, say hard disk or the like. Storage 140 may comprise multiple discrete memories together making up storage 140. Storage 140 may also be a temporary memory, say a RAM. In the case of a temporary storage 140, storage 140 contains some means to obtain encoded elements before use, say by obtaining them from an input, e.g., over an optional network connection (not shown), and the like.

Typically, the device 100 comprises a microprocessor (not separately shown) which executes appropriate software stored at the device 100; for example, that software may have been downloaded and/or stored in a corresponding memory, e.g., a volatile memory such as RAM or a non-volatile memory such as Flash (not separately shown). Alternatively, the device 100 may, in whole or in part, be implemented in programmable logic, e.g., as field-programmable gate array (FPGA). Device 100 may be implemented, in whole or in part, as a so-called application-specific integrated circuit (ASIC), i.e. an integrated circuit (IC) customized for their particular use. For example, the circuits may be implemented in CMOS, e.g., using a hardware description language such as Verilog, VHDL etc.

In an embodiment, device 100 comprises a storage circuit, an addition circuit, a reduction circuit. The device 100 may comprise additional circuits, e.g., a linear operator circuit, and an input and/or output circuit. The circuits implement the corresponding units described herein. The circuits may be a processor circuit and storage circuit, the processor circuit executing instructions represented electronically in the storage circuits. The circuits may also be, FPGA, ASIC or the like.

A processor circuit may be implemented in a distributed fashion, e.g., as multiple sub-processor circuits. A storage may be distributed over multiple distributed sub-storages. Part or all of the memory may be an electronic memory, magnetic memory, etc. For example, the storage may have volatile and a non-volatile part. Part of the storage may be read-only.

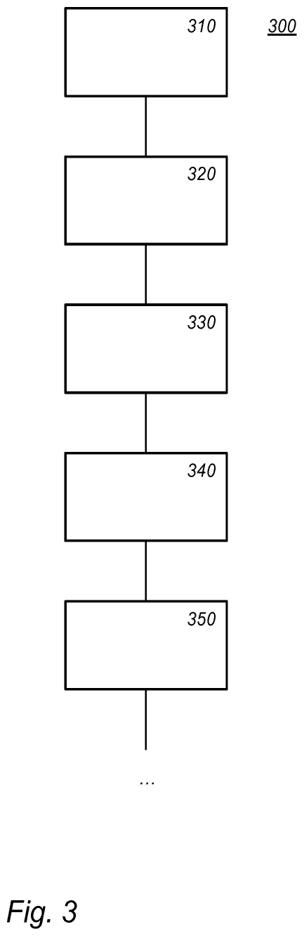

FIG. 3 schematically shows an example of an embodiment of an electronic computation device 300 arranged for the block cipher AES. The computation device 300 may be a so-called white-box implementation of the AES block cipher. This means that even if an attacker is given full low-level access to the program the implements that the block cipher, it should not be possible to derive the cryptographic key that is used to perform encryption and/or decryption operations.

Computation device 300 comprises units that implement the operations below. These operations may be implemented using the units shown in FIG. 1. For example, device 300 may be an embodiment according to FIG. 1, but with additional units, e.g., circuit and/or programming that implement the operations given below. The AES implementation may be in accordance with Federal Information Processing Standards Publication 197 Nov. 26, 2001, “Announcing the ADVANCED ENCRYPTION STANDARD (AES)”, included herein by reference.

AES implementation 300 shown in FIG. 3 comprises an add round key operation 310, a substitute bytes operation 320, a shift rows operation 330, a mix columns operation 340, an add round key operation 350. These operations operate on a state, e.g., as described in Fips 197. The state may be a sequence of bytes encoded according to an embodiment. For example, the state may be encoded on a per-byte basis, with each bye comprising at most one hook. Note that the full AES contain more of these operations, these are however fully similar and are only further shown in FIG. 3 as an ellipsis.

Note that this AES implementation is fully loop-unwinded. The round keys may be fixed and hard coded in the program. The round key may also be received through an input. For example, the state in the AES implementation may comprise only links, whereas the round keys comprise both a hooks and links, for each encoded byte. This allows the state and a round key to be added and reduced. The substitute bytes operation 320 may be implemented as look-up table. The substitute bytes operation 320 may be used to eliminate hooks as well, e.g., the table may receive a hook as input, and produce one more links as output. For example, AES 300 may be arranged so that reduction before the substitute bytes operation 320 fully reduces each byte of the state to only one hook. This will reduce the size of the table for operation 320. The shift rows operation 330 may be implemented on encoded bytes without a problem. The mix columns operation 340 is linear and may be implemented using a linear operator unit as described above.

Below a detailed example is given of selected embodiments.

We are going to consider N the abelian group of 7 elements, N=Z₇. The abelian group M will be Z₇² and the map π: M→N will be π(x, y)=2x+3y. The elements of M will be represented by ordered pairs (r, s) where r, s∈Z₇. The abelian group M is a vector space, therefore the elements of its automorphism group can be represented by square matrices. The elements of H and therefore the elements of A and G can be considered as matrices.

We are going to use a group A of order 3 that will be generated by the matrix

$$a = ( \begin{matrix}5 & 3 \\ 6 & 1\end{matrix} )$$

and the group G generated by the elements

$$g = ( \begin{matrix}0 & 1 \\ 2 & 1\end{matrix} ) and F = ( \begin{matrix}5 & 4 \\ 1 & 2\end{matrix} ) .$$

The order of f is 2 and the order of g is 6. These two matrices commute and also commute with a, therefore the group H=GA=AG is abelian. The number of elements of G is 12 and the number of elements of H is 36 because G n A is the identity.

The elements of G can be written as gⁱf^{j} with i∈{0,1,2,3,4,5} and j∈{0,1}. We can simplify the notation writing them as <i, j>. The group G is isomorphic to Z₆×Z₂ with the isomorphism given by <i, j>=gⁱf^{j}.

Given two elements <i, j> and <r, s> in G, they represent to gⁱf^{j} and g^{r}f^{s}. If we multiply them gⁱf^{j}g^{r}f^{s}=g^{i+r}f^{j+s} because the matrices f and g commute. Thus, the operation of <i, j> and <r, s> is precisely <i+r, j+s>. This rule let us use additive notation in the operations in G, because they are precisely the exponents and we will write <i, j>+<r, s>=<i+r, j+s>. The inverse of the element <i, j> is (gⁱf^{j})⁻¹=g⁻ⁱf^{-j} the precisely <−i, −j>.

Although it is not necessary to have this information to make computations, we are going to write the table with all the values of G in this notation, in multiplicative notation and also with matrices to have a clear correspondence between all the possible representations.

$$〈 0 , 0 〉 = {g}^{0} {f}^{0} = ( \begin{matrix}1 & 0 \\ 0 & 1\end{matrix} ) 〈 0 , 1 〉 = {g}^{0} {f}^{1} = ( \begin{matrix}5 & 4 \\ 1 & 2\end{matrix} )$$

$$〈 1 , 0 〉 = {g}^{1} {f}^{0} = ( \begin{matrix}0 & 1 \\ 2 & 1\end{matrix} ) 〈 1 , 1 〉 = {g}^{1} {f}^{1} = ( \begin{matrix}1 & 2 \\ 4 & 3\end{matrix} )$$

$$〈 2 , 0 〉 = {g}^{2} {f}^{0} = ( \begin{matrix}2 & 1 \\ 2 & 3\end{matrix} ) 〈 2 , 1 〉 = {g}^{2} {f}^{1} = ( \begin{matrix}4 & 3 \\ 6 & 0\end{matrix} )$$

$$〈 3 , 0 〉 = {g}^{3} {f}^{0} = ( \begin{matrix}2 & 3 \\ 6 & 5\end{matrix} ) 〈 3 , 1 〉 = {g}^{3} {f}^{1} = ( \begin{matrix}6 & 0 \\ 0 & 6\end{matrix} )$$

$$〈 4 , 0 〉 = {g}^{4} {f}^{0} = ( \begin{matrix}6 & 5 \\ 3 & 4\end{matrix} ) 〈 4 , 1 〉 = {g}^{4} {f}^{1} = ( \begin{matrix}0 & 6 \\ 5 & 6\end{matrix} )$$

$$〈 5 , 0 〉 = {g}^{5} {f}^{0} = ( \begin{matrix}3 & 4 \\ 1 & 0\end{matrix} ) 〈 5 , 1 〉 = {g}^{5} {f}^{1} = ( \begin{matrix}5 & 6 \\ 5 & 4\end{matrix} )$$

The number of G-orbits of M is 8. They are the orbit of 0 with only one element, three orbits with 2 elements, other three with 12 elements and one with 6 elements. The ones with three elements are

C={(5,1), (2,6)}

Ca={(3,2), (4,5)}

Ca²={(6,4), (1,3)}

The ones with 12 elements are

D={(1,0), (6,5), (2,1), (3,4), (2,3), (0,1), (5,4), (0,6), (4,3), (5,6), (6,0), (1,2)}

Da={(5,3), (4,2), (2,0), (4,6), (0,2), (6,1), (0,5), (1,6), (3,1), (5,0), (2,4), (3,5)}

Da²={(1,4), (4,0), (3,6), (0,4), (5,2), (1,5), (2,5), (6,2), (0,3), (4,1), (6,3), (3,0)}

and the one with 6 elements is

E=Ea=Ea²={(1,1), (2,2), (4,4), (6,6), (5,5), (3,3)}

In this case, we will consider as forbidden orbit the orbit of 0. All the other will be allowed.

We are going to choose two H-sets X and Y. As we have mentioned previously, one way to create the sets X and Y is to create multiple copies of G and make the disjoint union of them. We are going to use 7 copies of G in both cases. The elements of X and Y will be represented by <t: i, j> where t is an index between 0 and 7 that represents which copy of G we are using and the values i, j will represent the element of G taken from this fold. The maps [ ]: X→M and [ ]: Y→M will be generated by choosing elements x₀, x₁, . . . , x₆ in M and y₀, y₁, . . . , y₆ e M and giving the values:

<t:i,j>∈X [symbol] xᵢgⁱf^{j}∈M

<t:i,j>∈Y [symbol] yᵢgⁱf^{j}∈M

The elements xₜ and yₜ will be chosen one on each of the allowed orbits, in order to be able to represent all the allowed elements.

In the case of X, these elements will be x₀=(5,5)∈E, x₁=(3,1)∈Da, x₂=(5,1)∈C, x₃=(4,5)∈Ca, x₄=(1,3)∈Ca², x₅=(4,1)∈Da² and x₆=(6,0)∈D. For Y they will be y₀=(0,3)∈Da², y₁=(1,3)∈Ca², y₂=(3,5)∈Da, y₃=(3,4)∈D, y₄=(4,4)∈E, y₅=(2,6)∈C and y₆=(3,2)∈Ca.

In this case it has not been necessary to use a partial map for [ ] because we have no representation for the orbit of 0, therefore the forbidden elements are not in X or Y. The maps [ ]: X→M and [ ]: Y→M are not surjective because 0 is not in the image of them. But we have representations of 0 in N because π: M→N has nonzero elements in the kernel, for example, we can represent the element 0 in N by the pair (2,1) because π(2,1)=2·2+3·1=7=0∈Z₇. Using the fact that the element (2,1) is in the orbit D, we can use x₃ or y₂ with the corresponding element in G to represent this element in X and Y

To deal with these forbidden elements we are going to consider the map ι: M→Z₇ given by ι(x, y)=y. We will accept only the representations or combinations of them that generate values such that I applied over them is different from 0. The fact that 1 is linear let us control the value over the partial sums.

The notation <t: i, j> is very useful to represent the operations between the elements of X and Y and the elements of G, because we have (xₜgⁱf^{j})(g^{r}f^{s})=xₜg^{i+r}f^{j+s}, and using additive notation this can be written as <t: i, j>+<r, s>=<t: i+r, j+s> in both cases, even if they represent different elements for X or Y.

These operations follow the rules given by the operations in G, therefore i+r is computed in Z₆ and j+s is computed in Z₂.

We are going to define two box operators, W₀ and W₁. The operator W₀ will be of type (Xa⁰, Ya¹, m₀) and W₁ of type (Ya¹, Xa¹, m₁) for the values m₀=(2,1) and m₁=(6,2). These operators will generate maps W₀: X→Y and W₁: Y→X. These maps will take an element <t: i, j> in X or Y and give an output in the same representation. We will put the value t in the columns and the values i, j in the rows. With this notation, the table for W₀ is

| <t: i, j> | t = 0 | t = 1 | t = 2 | t = 3 | t = 4 | t = 5 | t = 6 |
|---|---|---|---|---|---|---|---|
| i, j = 0, 0 | <0: 2, 0> | <2: 2, 1> | <3: 4, 0> | <4: 2, 1> | <0: 3, 1> | <2: 3, 0> | <4: 2, 0> |
| i, j = 0, 1 | <0: 0, 0> | <2: 4, 0> | <3: 4, 0> | <4: 2, 1> | <0: 3, 1> | <2: 5, 0> | <4: 1, 0> |
| i, j = 1, 0 | <0: 4, 0> | <5: 0, 0> | <2: 3, 1> | <3: 1, 0> | <2: 0, 1> | <3: 0, 0> | <3: 3, 0> |
| i, j = 1, 1 | <0: 2, 1> | <0: 1, 1> | <2: 3, 1> | <3: 1, 0> | <2: 0, 1> | <3: 2, 1> | <3: 5, 1> |
| i, j = 2, 0 | <0: 4, 1> | <2: 0, 0> | <3: 4, 0> | <4: 2, 1> | <0: 3, 1> | <1: 1, 0> | undefined |
| i, j = 2, 1 | <5: 1, 0> | <2: 2, 0> | <3: 4, 0> | <4: 2, 1> | <0: 3, 1> | <2: 1, 1> | <4: 0, 1> |
| i, j = 3, 0 | <0: 2, 0> | <0: 5, 1> | <2: 3, 1> | <3: 1, 0> | <2: 0, 1> | <3: 4, 1> | <3: 1, 1> |
| i, j = 3, 1 | <0: 0, 0> | <0: 1, 0> | <2: 3, 1> | <3: 1, 0> | <2: 0, 1> | <3: 0, 1> | <3: 3, 1> |
| i, j = 4, 0 | <0: 4, 0> | <1: 0, 0> | <3: 4, 0> | <4: 2, 1> | <0: 3, 1> | <2: 5, 1> | <4: 1, 1> |
| i, j = 4, 1 | <0: 2, 1> | <2: 4, 1> | <3: 4, 0> | <4: 2, 1> | <0: 3, 1> | <2: 1, 0> | <4: 0, 0> |
| i, j = 5, 0 | <0: 4, 1> | <0: 3, 0> | <2: 3, 1> | <3: 1, 0> | <2: 0, 1> | <6: 1, 0> | <6: 0, 0> |
| i, j = 5, 1 | <5: 1, 0> | <0: 5, 0> | <2: 3, 1> | <3: 1, 0> | <2: 0, 1> | <3: 2, 0> | <3: 5, 0> |

and the table for W₁ is

| | | | | | | | |
|---|---|---|---|---|---|---|---|
| i, j = 0, 0 | <6: 4, 0> | <0: 0, 1> | <0: 1, 1> | <6: 5, 0> | <1: 4, 1> | <1: 5, 0> | <5: 0, 0> |
| i, j = 0, 1 | <3: 0, 0> | <0: 0, 1> | undefined | <6: 1, 1> | <1: 2, 1> | <1: 5, 0> | <5: 0, 0> |
| i, j = 1, 0 | <1: 1, 1> | <5: 3, 0> | <5: 5, 1> | <2: 1, 0> | <1: 0, 1> | <6: 0, 0> | <6: 3, 0> |
| i, j = 1, 1 | <1: 5, 1> | <5: 3, 0> | <5: 3, 1> | <5: 4, 0> | <1: 4, 0> | <6: 0, 0> | <6: 3, 0> |
| i, j = 2, 0 | <6: 4, 1> | <0: 0, 1> | <0: 1, 0> | <6: 3, 1> | <1: 0, 0> | <1: 5, 0> | <5: 0, 0> |
| i, j = 2, 1 | <6: 2, 0> | <0: 0, 1> | <0: 2, 1> | <6: 5, 1> | <4: 1, 0> | <1: 5, 0> | <5: 0, 0> |
| i, j = 3, 0 | <1: 3, 0> | <5: 3, 0> | <5: 1, 0> | <5: 2, 0> | <1: 4, 1> | <6: 0, 0> | <6: 3, 0> |
| i, j = 3, 1 | <4: 0, 0> | <5: 3, 0> | <2: 0, 0> | <5: 4, 1> | <1: 2, 1> | <6: 0, 0> | <6: 3, 0> |
| i, j = 4, 0 | <6: 2, 1> | <0: 0, 1> | <0: 2, 0> | <3: 1, 0> | <1: 0, 1> | <1: 5, 0> | <5: 0, 0> |
| i, j = 4, 1 | <6: 0, 1> | <0: 0, 1> | <0: 0, 0> | <6: 1, 0> | <1: 4, 0> | <1: 5, 0> | <5: 0, 0> |
| i, j = 5, 0 | <1: 3, 1> | <5: 3, 0> | <5: 1, 1> | <5: 0, 1> | <1: 0, 0> | <6: 0, 0> | <6: 3, 0> |
| i, j = 5, 1 | <1: 1, 0> | <5: 3, 0> | <5: 5, 0> | <5: 2, 1> | <4: 1, 0> | <6: 0, 0> | <6: 3, 0> |

The operators W₀ and W₁ are partial maps and they are not defined for all the elements. We have written the value undefined when the result should be 0, but this element is in a forbidden orbit and we not even have a representation for it. In the computations, these entries will not be accessed and we can put any value in the computer program if we prefer to have a complete table. These values will be used only in case an attacker insert some code and the idea would be to propagate errors in that case, therefore a fake value could be acceptable.

The group A generated by the matrix a that commutes with g and f is a group of order 3. Its elements are a⁰, a¹ and a². Having in mind that we have two bases and three elements in A, there are six types for the hooks, they are the following:)) H(X, a⁰), H(X, a¹), H(X, a²), H(Y, a⁰), H(Y, a¹), H(Y, a²).

We are using two values m₀ and m₁, therefore we have also six types for links, L(m₀, a⁰), L(m₀, a¹), L(m₀, a²), L(m₁, a¹), L(m₁, a²).

The operator W₀ has type (Xa⁰, Ya¹, m₀) and W₁ has type (Ya¹, Xa¹, m₁), therefore we have six possible reductions, three given by W₀:
R₀: H(X, a⁰)×L(m₀, a⁰)→H(Y, a¹)
R₁: H(X, a¹)×L(m₀, a¹)→H(Y, a²)
R₂: H(X, a²)×L(m₀, a²)→H(Y, a⁰)
and other three given by W₁:
T₀: H(Y, a¹)×L(m₁, a⁰)→H(X, a¹)
T₁: H(Y, a²)×L(m₁, a¹)→H(X, a²)
T₂: H(Y, a⁰)×L(m₁, a²)→H(X, a⁰)

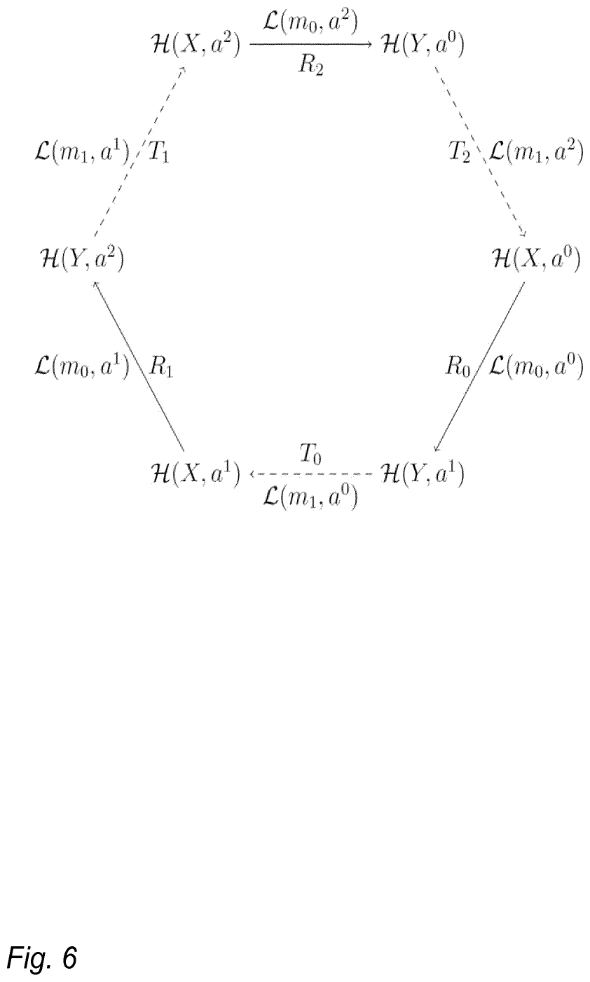

In the diagram of FIG. 6 we can see the six types of hooks and the six types of links with their reductions, that let us add a hook and a link if they have the correct type. The way to use this in an obfuscation algorithm is as follows. Suppose we have a permutation S: N→N and an algorithm that has to apply S and add a round key Kⁱ for rounds i=0, 1, . . . , r. The first round only adds the key K⁰.

An implementation of this algorithm could be like this:
The input will be a table such that for any possible n∈N we choose elements L₂⁰(n)∈L(m₁, a⁰) and I(n)∈H(Y, a⁰) such that π([I(n)])+π(L₂⁰(n))=n.
For the key K⁰ we choose values)L₀⁰(K⁰)∈L(m₁, a²), L₁⁰(K⁰)∈L(m₀, a⁰) and L₃⁰(K⁰)∈L(m₀, a¹) such that K⁰=π(L₀⁰(K⁰))+π(L₁⁰(K⁰))+π(L₃⁰(K⁰)).
For the keys Kⁱ with i=1, . . . , r−1 we choose values Lₗⁱ(Kⁱ)∈L (m₀, a⁰) and L₃ⁱ(Kⁱ)∈L(m₀, a¹) such that Kⁱ=π(Lₗⁱ(Kⁱ))+π(L₃ⁱ(Kⁱ)).
For the last key K^{r} we choose values Lₗ^{r}(K^{r})∈L(m₀, a⁰), L₃^{r}(K^{r})∈L(m₀, a¹) and L₄^{r}(K^{r})∈L(m₁, a₁) such that K^{r}=π(Lₗ^{r}(K^{r}))+π(L₃^{r}(K^{r}))+π(L₄^{r}(K^{r})).
For the permutation, we will have a table such that for any J∈H(Y, a²) we have elements H(J)∈H(X, a⁰) and L₂(J)∈L(m₁, a⁰) such that π([H(J)])+π(L₂(J))=S(π([H])).

We may have to define the input table, and for all the elements n∈N we have to choose I(n)∈H(Y, a⁰) and L₂⁰(n)∈L(m₁, a⁰) satisfying the conditions given.

| n | L₂⁰(n) | I(n) |
|---|---|---|
| 0 | <4, 0> | <6: 0, 0> |
| 1 | <5, 0> | <3: 2, 1> |
| 2 | <5, 0> | <0: 1, 1> |
| 3 | <4, 0> | <3: 2, 1> |
| 4 | <5, 0> | <0: 2, 0> |
| 5 | <4, 0> | <4: 2, 0> |
| 6 | <5, 0> | <2: 2, 1> |

For the key K⁰ we have two choose possible links for all possible values of the key, one possible choice is:

| K⁰ | L₀⁰(K⁰) | L₁⁰(K⁰) | L₃⁰(K⁰) |
|---|---|---|---|
| 0 | <4, 1> | <3, 1> | <3, 1> |
| 1 | <1, 1> | <1, 1> | <3, 0> |
| 2 | <4, 1> | <0, 1> | <1, 1> |
| 3 | <0, 0> | <1, 1> | <1, 0> |
| 4 | <0, 1> | <5, 0> | <5, 0> |
| 5 | <5, 0> | <4, 0> | <5, 0> |
| 6 | <1, 0> | <4, 0> | <5, 0> |

We are going to make an example of computation in the first round. Suppose that we have the initial value n=3 and we have to add the key K⁰=2. Looking at the tables, these elements are represented by the following elements:
The initial value n=3 will be given by
   I(3)=<3: 2,1>, a hook of type H(Y, a⁰)
   L₂⁰(3)=<4,0>, a link of type L(m₁, a⁰).
The key K⁰=2 will be given by three links
   L₀⁰(2)=<4,1>, a link of type L(m₁, a²)
   L₁⁰(2)=<0,1>, a link of type L(m₀, a⁰)
   L₃⁰(2)=<1,1>, a link of type L(m₀, a¹)

The addition of these elements would be (I(3)+L₂⁰(3))+(L₀⁰(2)+L₁⁰(2)+L₃⁰(2)), but in this order the elements cannot be added because they are not in the correct positions. We need a reduction path that tell us the precise order that we have to use in order to make the reductions. In this particular example, there is only one possibility, but in general we could have more than one option. The order will be the following I(3)+L₀_{₀}(2)+L₁⁰(2)+L₂⁰(3)+L₃⁰(2). In this order, we have to add a part of the initial value with part of the key, add the second part of the initial value and finally the last part of the key.

The operations will be the following:

1. We have to add the hook I(3)=<3: 2,1> and the link L₀⁰(2)=<4,1>. The reduction applied will be T₂ with the box operator W₁. The reduction has always three steps, operate with the inverse of the group represented by the link, apply the box operator and finally operate back with the group represented by the link.

(a)<3: 2-4, 1-1>=<3: 4,0>

(b) W₁(<3: 4,0>)=<3: 1,0>

(c)<3: 1+4,0+1>=<3: 5,1>

2. The output of the first operation <3: 5,1>, that it is a hook of type H(X, a⁰) will be operated with the link L₁⁰(2)=<0,1> using the reduction R₀ that is induced by the box operator W₀.

(a)<3: 5-0, 1-1>=<3: 5,0>

(b) W₀(<3: 5,0>)=<3: 1,0>

(c)<3: 1+0,0+1>=<3: 1,1>

3. This output <3: 1,1>, that is a hook of type H(Y, a¹) will be operated with the link L₂⁰(3)=<4,0> using the reduction T₀ that is induced by the box operator W₁.

(a)<3: 1-4, 1-0>=<3: 3,1>

(b) W₁(<3: 3,1>)=<5: 4,1>

(c)<4: 4+4,1+0>=<5:2,1>

4. This output <5: 2,1>, that is a hook of type H(X, a¹) will be operated with the link L₃⁰(2)=<1,1> using the reduction R₁ that is induced by the box operator W₀.

(a)<5: 2-1, 1-1>=<5: 1,0>

(b) W₀(<5: 1,0>)=<3: 0,0>

(c)<3:0+1,0+1>=<3:1,1>

5. The final result of this round will be <3: 1,1>, that is a hook of type H(Y, a²). If we apply the [ ] and r operators to this element, we obtain precisely 5 the is the addition of the initial value 2 and the key 3

π([<3: 1,1>])=π(y₃g¹f¹a²)=π(2,5)=2·2+3·5=19=5 (mod 7)

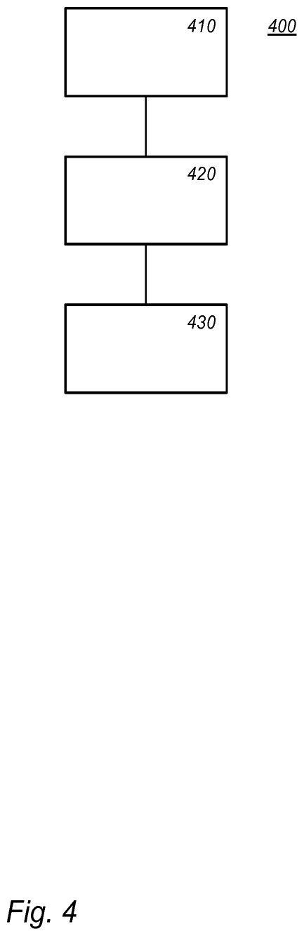

FIG. 4 schematically shows an example of an embodiment of an electronic computation method 400. Electronic calculating method 400 is arranged for encoded addition in an Abelian group N, Method 400 comprises
storing (410) encoded elements of the Abelian group N, the storing comprising storing elements encoded in the following forms:
in a first form (110), of one or more types, a type of the first form ( [symbol] (x, b)) being defined by a set X, an element b of a group A, and a map [ ]: X→M, wherein an element x of the set X represents the element m([x]b) of the Abelian group N, wherein
   π is a homomorphic surjective projection π: M→N from an Abelian group M to the group N,
   the group A and a group G together decompose a subgroup H of the automorphism group Aut(M), wherein H=GA, the groups A and G having the property that ga=ag for any a in A and g in G, the group H having an action on the set X,
   the map [ ] is an at least partial map [ ]: X→M, such that [xh]=[x]h for any x in x and h in H, where the map is defined, and wherein the composition π[ ]: X→N is surjective,
   in a second form (120), of at least one type, a type of the second form ( [symbol] (m, b′)) being defined by an element m of the group M and an element b′ of the group A, wherein an element g of the group G represents the element π(mgb′) of Abelian group N,
   in a third form (130) an element of Abelian group N is encoded as a sequence of encoded elements, wherein the sequence in the third form comprises at least two encoded elements encoded according to the first or second form, the sequence of encoded elements representing the sum in the Abelian group N of the elements in the Abelian group N that are represented by the elements in the sequence,
adding (420) multiple encoded addends, wherein the addition unit is configured to form an encoded element of the third form comprising at least the encoded parts of the multiple encoded addends, and
reducing (430) an encoded element of the third form, by replacing in the sequence of the encoded elements, a first encoded element x of the first form of type defined by the set x and an element ab of the group A and a second encoded element g of the second form of type defined by an element m of the group M and an element b of the group A, with an encoded element of the first form w(xg⁻¹)g and type ( [symbol] (Y, a′b)) defined by a second set Y and the product (a′b) of an element a′ and the element b, wherein
the reduction unit being provided with a reduction function w, which is a function from a first set X to a second set Y, the function w having a type ((x, a, Y, a′, m)) defined by first set X, second set Y, the element a of A, the element a′ of A, and the element m of the group M, the function w having [xa]+m=[W(x)a′] for all x in X, a and a′ in A, m in M, for which the map [ ] is defined.

Many different ways of executing the method are possible, as will be apparent to a person skilled in the art. For example, the order of the steps can be varied or some steps may be executed in parallel. Moreover, in between steps other method steps may be inserted.

The inserted steps may represent refinements of the method such as described herein, or may be unrelated to the method. For example, storing, addition and reduction steps may be executed, at least partially, in parallel. Moreover, a given step may not have finished completely before a next step is started.

A method according to the invention may be executed using software, which comprises instructions for causing a processor system to perform method 400. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. A method according to the invention may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source, and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

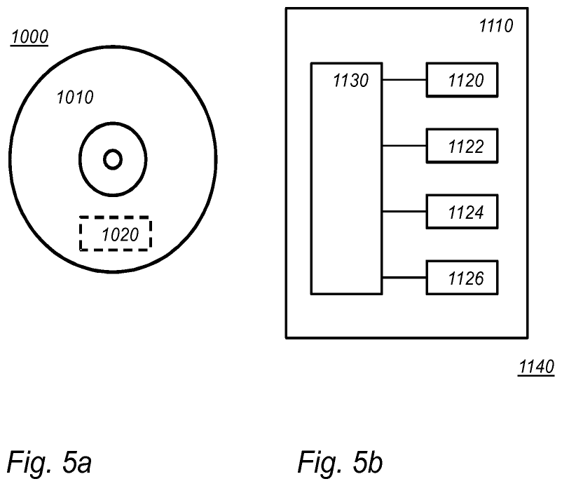

FIG. 5a shows a computer readable medium 1000 having a writable part 1010 comprising a computer program 1020, the computer program 1020 comprising instructions for causing a processor system to perform a calculating method according to an embodiment. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable. The computer program 1020 comprises instructions for causing a processor system to perform said calculation method.

FIG. 5b shows in a schematic representation of a processor system 1140 according to an embodiment. The processor system comprises one or more integrated circuits 1110. The architecture of the one or more integrated circuits 1110 is schematically shown in FIG. 5b. Circuit 1110 comprises a processing unit 1120, e.g., a CPU, for running computer program components to execute a method according to an embodiment and/or implement its modules or units. Circuit 1110 comprises a memory 1122 for storing programming code, data, etc. Part of memory 1122 may be read-only. Circuit 1110 may comprise a communication element 1126, e.g., an antenna, connectors or both, and the like. Circuit 1110 may comprise a dedicated integrated circuit 1124 for performing part or all of the processing defined in the method. Processor 1120, memory 1122, dedicated IC 1124 and communication element 1126 may be connected to each other via an interconnect 1130, say a bus. The processor system 1110 may be arranged for contact and/or contact-less communication, using an antenna and/or connectors, respectively.

For example, in an embodiment, the calculation device may comprise a processor circuit and a memory circuit, the processor being arranged to execute software stored in the memory circuit. For example, the processor circuit may be an Intel Core i7 processor, ARM Cortex-R8, etc. The memory circuit may be an ROM circuit, or a non-volatile memory, e.g., a flash memory. The memory circuit may be a volatile memory, e.g., an SRAM memory. In the latter case, the verification device may comprise a non-volatile software interface, e.g., a hard drive, a network interface, etc., arranged for providing the software. The software comprises: storage instructions, addition instructions, and reduction instruction. The software may also comprise input and/or output instruction and/or linear operator instructions. The instructions implementing an embodiment of a corresponding unit described herein.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In the claims references in parentheses refer to reference signs in drawings of exemplifying embodiments or to formulas of embodiments, thus increasing the intelligibility of the claim. These references shall not be construed as limiting the claim.

### LIST OF REFERENCE NUMERALS IN FIGS. 1-3

100 a calculating device
110 multiple encoded elements of the first form
112 an encoded element of the first form of a first type
114 an encoded element of the first form of a second type
116 an encoded element of the first form of a third type
120 multiple encoded elements of the second form
122 an encoded element of the second form of a first type
124 an encoded element of the second form of a second type
126 an encoded element of the second form of a third type
130 multiple encoded elements of the third form
131 an encoded element of the third form
132 an encoded element of the third form
140 a storage
150 an addition unit
160 a reduction unit
170 an input/output unit
180 a linear operator unit
210 an encoded element of the third form
220 an encoded element of the third form
212, 214, 222-226 an encoded element of the first or second form
214 an encoded element of the first form
226 an encoded element of the second form
230 an encoded element of the third form
231 an encoded element of the third form
300 an AES implementation
310 an add round key operation
320 a substitute bytes operation
330 a shift rows operation
340 a mix columns operation
350 an add round key operation

1. An electronic calculating device arranged for white-box encoded addition in an Abelian group N, comprising
a storage configured to store encoded elements of the Abelian group N, the storage comprising elements encoded in the following forms:
in a first form, of one or more types, a type of the first form ( [symbol] (X, b)) being defined by a set X, an element b of a group A, and a map [ ]: X→M, wherein an element X of the set X represents the element π([x]b) of the Abelian group N, wherein
π is a homomorphic surjective projection π: M→N from an Abelian group to the group N,
the group A and a group G together decompose a subgroup H of the automorphism group Aut(M), wherein H=GA, the groups A and G having the property that ga=ag for any a in A and g in C, the group H having an action on the set X,
the map [ ] is an at least partial map [ ]: X→M, such that [xh]=[x]h, for any x in X and h in H, where the map is defined, and wherein the composition π[ ]: X→N is surjective,
in a second form, of at least one type, a type of the second form ( [symbol] (m, b′)) being defined by an element m of the group M and an element b′ of the group A, wherein an element g of the group G represents the element π(mgb′) of Abelian group N,
in a third form an element of Abelian group N is encoded as a sequence of encoded elements, wherein the sequence in the third form comprises at least two encoded elements encoded according to the first or second form, the sequence of encoded elements representing the sum in the Abelian group N of the elements in the Abelian group N that are represented by the elements in the sequence, and
a processor circuit arranged with
an addition unit arranged to add multiple encoded addends, wherein the addition unit is configured to form an encoded element of the third form comprising at least the encoded parts of the multiple encoded addends, and
a reduction unit arranged to reduce an encoded element of the third form, by replacing in the sequence of the encoded elements, a first encoded element x of the first form of type defined by the set X and an element ab of the group A and a second encoded element g of the second form of type defined by an element m of the group M and an element b of the group A, with an encoded element of the first form W(xg⁻¹)g and type ( [symbol] (Y, a′b)) defined by a second set V and the product (a′b) of an element a′ and the element b, wherein
the reduction unit being provided with a reduction function W, which is a function from a first set x to a second set Y, the function W having a type ((X, a, Y, a′, m)) defined by first set X, second set Y, the element a of A, the element a′ of A, and the element m of the group M, the function W having [xa]=[W(x)a] for all x in Y, a and a′ in A, m in M, for which the map [ ] is defined.

2. An electronic calculating device as in claim 1, wherein the first set X and the second set V are the same.

3. An electronic calculating device as in claim 1, wherein the storage comprises elements of the first form of type defined by a second set Y, and an element b of the group A, and a map [ ]: Y→M, wherein an element x of the set Y represents the element π([x]b) of the Abelian group N, wherein the map [ ] is an at least partial map [ ]: Y→M, such that [xh]=[x]h for any x in Y and h in H, where the map is defined, and wherein the composition n[ ]: Y→N is surjective.

4. An electronic calculating device as in claim 1, wherein the reduction unit is arranged with one more reduction functions W, an encoded element of a type of the first form ( [symbol] (X, ab)) being defined by a set X, and element ab of the group A and an encoded element of a type of the second form ( [symbol] (m, b)) defined by an element m of the group M and an element b of the group A are compatible if the reduction unit is arranged with a reduction function W of type (X, a, Y, a′, m), the reduction unit being arranged to apply a corresponding reduction function to two compatible encoded elements of the first and second form in a sequence of encoded elements of the third form.

5. An electronic calculating device as in claim 4, wherein
a first addend is of the third form and comprises an encoded element of the first form and an encoded element of the second form, that are not compatible,
a second addend comprises an encoded element of the second form compatible with the encoded element of the first form in the first addend.

6. An electronic calculating device as in claim 1, wherein the composition π([W( )]) is surjective on N.

7. An electronic calculating device as in claim 1, comprising
a plain input arranged to receive an element of Abelian group N, and to convert the received element into an encoded element of the first, second or third form, e.g., using a look-up table, and/or
a plain output arranged to receive an encoded element of the first, second or third form and to convert the received element to an unencoded element of Abelian group N.

8. An electronic calculating device as in claim 1, wherein the groups M and N are the same, and wherein the projection π is the identity.

9. An electronic calculating device as in claim 1, wherein the groups M and N are modules over a ground ring, the groups H, G and A being matrix groups over the ground ring.

10. An electronic calculating device as in claim 1, wherein the group A is a matrix group comprising only diagonal and/or anti-diagonal matrices.

11. An electronic calculating device as in claim 1, wherein the Abelian group N is the group [symbol] ₂ⁿ for n≥2.

12. An electronic calculating device as in claim 1, wherein the first and/or second set is a disjoint union of one or more copies of the group H.

13. An electronic calculating device as in claim 1, wherein the processor circuit is arranged with a linear operator unit, arranged to apply a linear operator to an encoded element.

14. An electronic calculating device as in claim 1, wherein the first set X is an Abelian group X, such that the group H is a common subgroup of the automorphism group Aut(X) and the automorphism group Aut(M).

15. An electronic calculating method arranged for white-box encoded addition in an Abelian group N, comprising
storing encoded elements of the Abelian group N, the storing comprising storing elements encoded in the following forms:
in a first form, of one or more types, a type of the first form ( [symbol] (X, b)) being defined by a set X, an element b of a group A, and a map [ ]: X→M, wherein an element x of the set X represents the element π([x]b) of the Abelian group A, wherein
π is a homomorphic surjective projection π: M→N from an Abelian group M to the group N,
the group A and a group G together decompose a subgroup H of the automorphism group Aut(M), wherein H=GA, the groups A and G having the property that ga=ag for any a in A and g in G, the group H having an action on the set X,
the map [ ] is an at least partial map [ ]: X→M, such that [xh]=[x]h for any x in X and h in where the map is defined, and wherein the composition [ ]: X→N is surjective,
in a second form, of at least one type, a type of the second form ( [symbol] (m, b′)) being defined by an element m of the group and an element b′ of the group A, wherein an element g of the group G represents the element π(mgb′) of Abelian group N,
in a third form an element of Abelian group IV is encoded as a sequence of encoded elements, wherein the sequence in the third form comprises at least two encoded elements encoded according to the first or second form, the sequence of encoded elements representing the sum in the Abelian group N of the elements in the Abelian group N that are represented by the elements in the sequence,
adding multiple encoded addends, wherein the addition unit is configured to form an encoded element of the third form comprising at least the encoded parts of the multiple encoded addends, and
reducing an encoded element of the third form, by replacing in the sequence of the encoded elements, a first encoded element of the first form of type defined by the set X and an element ab of the group A and a second encoded element g of the second form of type defined by an element m of the group M and an element b of the group A, with an encoded element of the first form W(xg⁻¹)g and type ( [symbol] (Y, a′b)) defined by a second set Y and the product (a′b) of an element a′ and the element b, wherein
the reduction unit being provided with a reduction function W, which is a function from a first set X to a second set Y, the function W having a type (X, a, Y, a′, m)) defined by first set X, second set Y, the element a of A, the element a′ of A, and the element m of the group M, the function W having [xa]+m=[W/(x)a′] for all x in X, a and a′ in A, m in M, for which the map [ ] is defined.

16. A computer readable medium comprising transitory or non-transitory data representing instructions to cause a processor system to perform the method according to claim 15.
